(19) United States
(12) Patent Application Publication
(10) Pub. No.: US 2005/0289078 A1
(43) Pub. Date: Dec. 29, 2005

(54) Electronic signature method

(76) Inventors: Jean-Philippe Wary, Bourg La Reine (FR); Guillaume Bailliard, Neuilly Sur Seine (FR)

Correspondence Address: PERMAN & GREEN, 425 POST ROAD, FAIRFIELD, CT, 06824, US

(21) Appl. No.: 10/499,081

(22) PCT Filed: Dec. 5, 2002
(86) PCT No.: PCT/FR02/04197

§ 371 Date: Jul. 15, 2005

(30) Foreign Application Priority Data
Dec. 21, 2001 (FR) 01/16793

(51) Int. Cl. H04L 9/00

(52) U.S. Cl. 705/64

(57) ABSTRACT

A method in which a telephony operator acts as a recording authority and certification authority for secured transactions between a subscriber and a provider. Communications between the subscriber (101) and the operator (113) are signed with a symmetrical algorithm (108c, 117C). The communications between the operator and the provider are countersigned according to PKI technologies (117E, 124A), and an asymmetrical algorithm. Two configurations are possible: either the operator signs the contents of each of the subscriber/provider transactions with his own dual key, after validation, or the operator implements a secure and repudiable signature transfer, in his network, to a remote terminal (using a secret key technology This reduces the resources needed for a subscriber's terminal. It also gives the operator greater visibility of the operations occurring in his network and ensures the validity of the transactions.

An object of the present invention is an electronic signature method. The present invention is part of the field of the electronic signatures as understood in European directives and French decrees. The field of the invention is also that of transactions made between a subscriber to a telecommunications network and a service provider using said telecommunications network to propose services.

It is an aim of the invention to set up a simplified electronic signature system in a closed network such as, for example, a mobile telephony cell network or a pay television network. It is another aim of the invention to enable the setting up of a chain of proofs between a signatory, for example a subscriber or an operator, and a provider, for example a provider of services or contents, or a tradesman, so as to be able to secure a transaction made between the signatory and the provider. It is another aim of the invention to simplify the means implemented at a terminal used by a subscriber to make a transaction. It is another aim of the invention to make the certification mechanisms as transparent as possible for its users, namely the subscriber and the providers.

In the field of transactions, the most commonly known transactions are those that correspond to purchases and sales. However, it is possible to consider a transaction as corresponding to the fact of transmitting information to a partner, where it is the responsibility of this partner to ascertain that the information transmitted to him is not vitiated by deception. It is also possible to envisage the use of the invention within the framework of access control, the transaction resulting in this case from an access authorization request. For simplicity's sake, the invention shall be described in the context of a purchase operation, because such an operation is truly representative of all the problems that may arise during such a transaction. However, all transactions are concerned by the invention.

In the field of purchases, especially purchases on the Internet, a purchaser, for example a user of a mobile telephone, gets connected to a service provider, especially during a WAP (Wireless Application Protocol) or voice session. During this session, the user agrees on a transaction with a provider. The provider is then a provider of goods or services who places his goods or his services at the disposal of the user through a transaction (the consumption of the item may be immediate, for example in the case of a set of musical contents or it may be deferred in the case of an online order). This transaction is made by an exchange of messages between the user and the provider. These transaction messages are composed on the user side and on the provider side. These are electronic messages composed either by the mobile telephone under the user's control, or by a server of the provider, this server being then connected to the Internet or accessing the mobile operator's network. If the transaction consists of a purchase, the messages exchanged comprise chiefly the following pieces of information: an identifier of the purchaser, an identifier of the product purchased, a quantity of products purchased, a unit price for the product, as well as a timestamp. In the case of a sale, the transaction message may be signed by the provider before it is sent to the user. The enciphering of the transactions is not a security obligation that may be implemented to reinforce its level. The user then only has to verify the signature of the message, if it is present, and then if he has trust in the pattern of signature used by the provider and if the descriptive content of the transaction corresponds to what he is expecting, the user may sign the message received to send it for approval to the provider. When the provider receives a new message, he analyses the content of the message and consistency and validates signature placed by the user on this message. If the signature is valid, the provider can then fulfill his part of the transaction.

In the prior art, the securing of a transaction between a subscriber and a provider is achieved by the implementation of the technology known as the PKI (Public Key Infrastructure) technology. To enable the use of this technology, and hence the making of a transaction with a provider, the subscriber must have a certificate, the best-known of the certificates being the X509 certificates. Such a certificate is delivered by a certification authority on the basis of information collected by a recording authority. The role of the recording authority is to verify the data of the certificate applications with respect to the security procedures drawn up by the certification authority. To obtain his certificate, the subscriber must therefore provide a certain number of pieces of information to the recording authority which will make sure of the validity of this information before requesting the certification authority to generate a certificate. The certification authority then delivers a certificate, for example X509. An X509 certificate is a file, accessible to all, comprising the identity of the holder of the certificate, a public key, a serial number, a period of validity, the localizing of a list of associated revocation operations and a certain number of other items of information unrelated to the invention.

The PKI technologies are based on enciphering algorithms known as asymmetrical algorithms. Such algorithms use an enciphering key and a deciphering key that are different. The term “dual key” is also used. A file enciphered with one of the keys of the dual key can be deciphered only by using the other key of the dual key. One of the keys of the dual key is said to be private, and known only to the holder of the certificate, while the other key of the dual key is said to the public and is known to all. In general, it is the certification authority that produces the dual keys. The certification authority also provides information on the state of corruption of the private key. The certification authority ensures that the private key of the dual key is known only to its holder. The certification authority repudiates a certificate when it is convinced that the private key is no longer private. The certificate then becomes useless and is repudiated.

Thus in the prior art, when the subscriber is in possession of the transaction message, and of an X509 certificate, he can sign the transaction. The signing of the transaction is done firstly by the production of a fingerprint of the message representing the transaction (this is called a transaction message or quite simply a transaction). The algorithm generally applied to this transaction message is an algorithm of the MD5 (Message Digest 5) or SHA (Secure Hash Algorithm) type. The fingerprint of the message is then enciphered using the private key of the holder of the X509 certificate. The result is called the electronic signature (or signature message) of the transaction message. Since the private key is known only to the holder of the certificate, anyone who receives the signature and succeeds in deciphering it by means of the public key of the certificate is assured that the signature has been truly produced by the holder of the certificate.

Furthermore, the MD5 or SHA type algorithms are irreversible, i.e. it is impossible to reconstitute the original message from the hashed message. To the extent that the person receiving the message and the signature knows the algorithm used for the hashing, he or she is capable of recomputing the fingerprint and therefore of comparing it with the result of the deciphering of the signature. It may be noted that an X509 certificate provides information also on the algorithm used to produce the signature. If there is concordance, then the message has been transmitted accurately and by an identified person. The provider, having received the transaction message and the signature that accompanies it, is then assured of the validity of the transaction.

The prior art solution therefore truly fulfils the imperatives of confidentiality and non-repudiation related to the proper running of the transaction. However, this solution has many drawbacks.

The first drawback is that the subscriber must obtain a certificate from the certification authority. He must therefore engage in administrative type procedures to obtain this certificate. The procedures are not highly complex. However, at the present time, for the common man, the notion of a certificate remains highly mysterious and does not encourage him to take the necessary steps to obtain a certificate when he does not see it as an absolutely necessity.

A second drawback is that a certificate is linked to a dual key, implemented by using an algorithm known as the RSA. The robustness of the algorithm depends, inter alia, on the length of the keys of the dual key.

The drawback of the prior art then is that the RSA is based on factorisations of numbers. Its implementation therefore calls for major computations, and even the furnishing of specialized means, for example a wired component, to obtain performance compatible with real-time use. The term “real-time use” is understood to mean a waiting time compatible with a man/machine interface (2 to 3 seconds). The integration of the RSA algorithm, for example into a mobile telephone, therefore considerably increases the cost of the apparatus.

A third drawback of the prior art is related to the second one: the telecommunications operator who places means at the disposal of his subscribers specific to the implementation of the RSA algorithm does not necessarily get any return on his investment. Indeed, every transaction can be made without any specific intervention by the telecommunications operator.

The invention resolves these problems by placing the telecommunications operator at the center of the transactions made on his telecommunications network. Thus, the operator can combine the roles of telecommunications operator, recording authority, certification authority and also, to a smaller extent, signatory of transaction messages. The fundamental point however is that he gives the user and the provider an efficient guarantee of the validity of the transaction. The extent is smaller because the only thing left to the operator for the signatures is the implementation of the PKI to validate the signature of a subscriber in countersigning it.

In the invention, a subscriber wishing to make a transaction produces a message corresponding to this transaction. When the transaction message is constituted, it is signed by means of signature technologies known as symmetrical technologies. Such technologies are based on the use of secret keys, which is a use consistent with closed networks such as mobile telephony networks, or pay television networks, since, by definition, all the actors are known without exception. There are indeed known ways of conveying a secret in such closed networks (by making available chip cards, SIM cards in the context of a GSM/GPRS network, for example). Furthermore, symmetrical signature technologies consume far less in terms of computation resources. In symmetrical signature technologies, it is possible to use known deciphering algorithms such as the DES (Data Encryption Standard), triple DES or again the AES (Advanced Encryption Standard). The subscriber uses a secret key, known to himself and to the operator, to produce a signature of a transaction message composed by the subscriber. This message and it signature then sent to the operator who verifies the signature, and then (using RSA technology for example) countersigns the unit forming the transaction message and the signature in using asymmetrical signature technologies before sending the message from the user to the provider. This provider may, for example, be localized on the Internet, and the operator makes a countersignature using the model commonly implemented on the Internet: the PKI technology based on the use of X509 certificates.

In the invention, the operator acts as certification authority. This means that it is the operator who produces the certificates used by his subscribers to make transactions. Thus, for example, the operator may decide to associate the same dual key with several subscribers, the certificate being then differentiated by the other elements that constitute it, such as for example of the identity of the holder of the certificate, its serial number, its date of creation, or its date of expiry.

When he receives the transaction message and its signature, the operator formally knows the sender of the message. He is then in a position to retrieve the secret key associated with this subscriber. He uses this secret key to verify the signature of the transaction message. If his analysis of the signature validates it as coming from the subscriber, then the operator is in a position to countersign the entire transaction of the subscriber (namely the transaction message and his signature in symmetrical technology) with his own operator dual key before sending the new message to the provider. The subscriber, for his part, is unable to analyze the signature made by the subscriber, but the operator for his part, in countersigning the unit, certifies the validity of the transaction. The provider may therefore accept the signature. The problem of trust in the signature of an unknown subscriber is transformed into a problem of trust in a known operator guaranteeing the validity of the transaction.

Thus, the imperatives of non-repudiation, low computation load for the subscriber's terminal, and visibility by the operator are achieved, these being the goals sought by the invention.

An object of the invention therefore is an electronic signature method, characterized by the fact that it comprises the following steps:
information is displayed (201) on a terminal of the user, this information pertaining to the nature of a transaction T between the user and a provider,
a signature of the transaction T (203) is produced on the terminal to authenticate the transaction T and the author of the transaction T,
on the terminal, there is produced a first message comprising the information relative to the nature of the transaction T and its signature,
the first message is sent (204), from the terminal to the server of a telecommunications operator,
the first message is received (205) on the server of the telecommunications operator,
the user of the terminal is identified on the server,
the validity of the signature is verified (206), on the server,
a second transaction, comprising the transaction T, the signature of the user of the terminal and information on the identity of the user of the terminal, is produced (207) on the server,
a signature corresponding to the second transaction is produced (209), this signature being called the operator's countersignature,
a second message, comprising the second transaction and its countersignature by the operator, is sent (210), from the server to the provider who is party to the transaction T.

It is understood that this situation is situated in the specific case where the user signs a transaction and sends it to the provider. The case where the provider starts by signing a transaction before submitting it to the user for his signature can also be deduced from these steps.

The invention will be understood more clearly from the following description and the accompanying figures. These figures are given purely by way of an indication and in no way restrict the scope of the invention. Of these figures

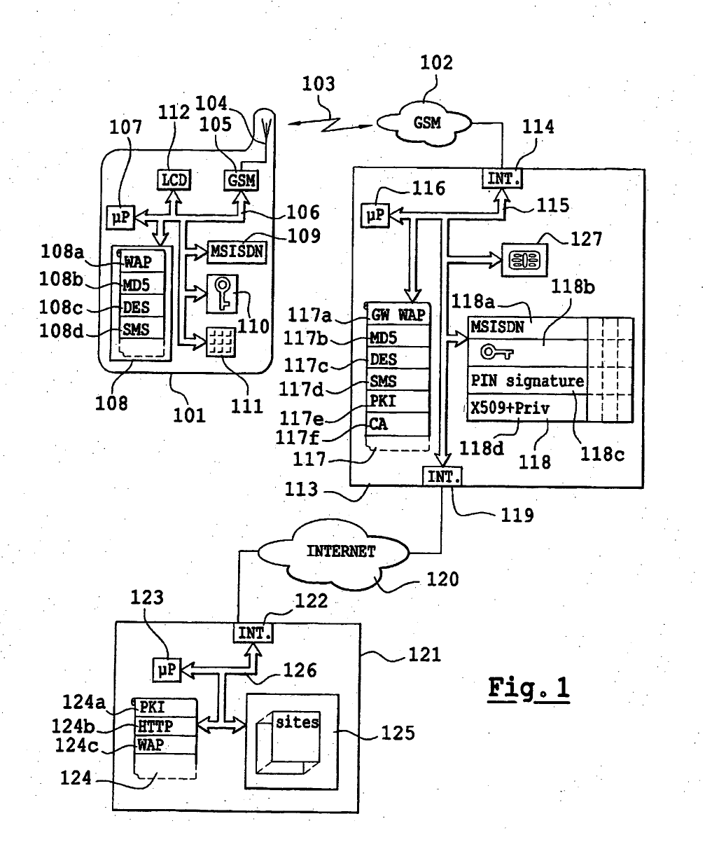

FIG. 1 illustrates means necessary for the implementation of the method according to the invention;

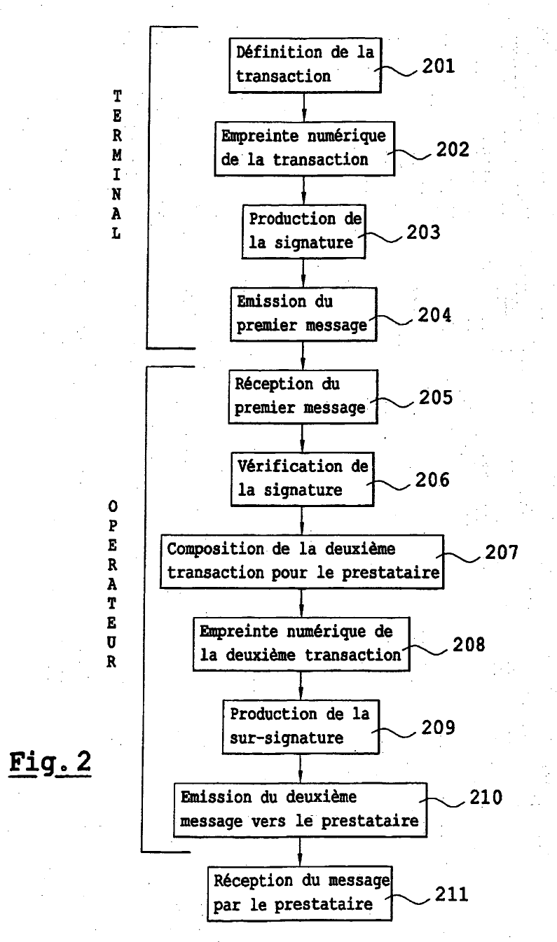

FIG. 2 illustrates steps of the method according to the invention;

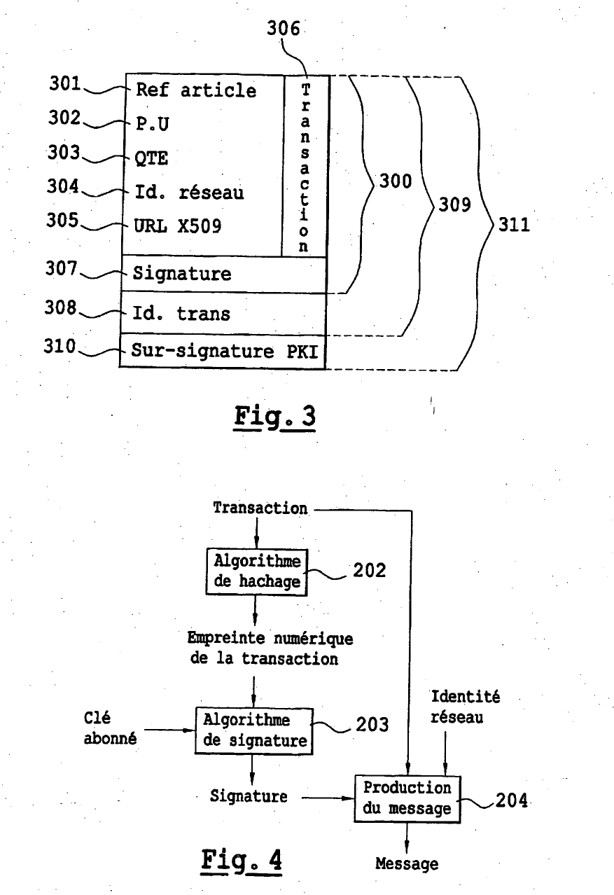

FIG. 3 illustrates a transaction message composed by a subscriber;

FIG. 4 illustrates steps implemented for the production of a signed and enciphered message representing the transaction.

FIG. 1 shows a telephone 101 connected to a mobile telephony network 102. In the present example, the terminal which can be used to receive or produce information on the nature of a transaction is therefore a mobile telephone. In practice, it may be any type of apparatus used to link up to a telecommunications network. Similarly, the network 102 is considered to be a GSM network but it could be any type of telecommunications network among existing networks such as, for example, the DCS, PCS, GPRS networks or the future network such as the UMTS.

The telephone 101 therefore sets up an RF link 103 with the network 102. This link is set up by means of an antenna 104 of the telephone 101. The antenna 104 is connected to GSM circuits 105. The circuits 105 have a role of modulation and demodulation of signals. Firstly, they demodulate the signals received from the network 102 via the antenna 104 to produce digital signals. Secondly, the circuits 105 produce analog signals, according to the GSM standard, from digital signals. The circuits 105 are therefore connected to a bus 106.

The telephone 101 also has a microprocessor 107 connected to the bus 106. The microprocessor 107 executes instruction codes recorded in a program memory 108. The memory 108 has several zones. A zone 108A comprises instruction codes on the implementation of the communications protocol, for example the WAP or HTTP protocols. A zone 108B comprises instruction codes on the implementation of the MD5 or SHA-1 type fingerprint computation algorithm.

A zone 108c comprises the instruction codes on the implementation of an enciphering algorithm, for example the DES, 3DES, EAS algorithms. Finally, a zone 108d comprises instruction codes on the sending and reception of SMS (Short Message System) messages. The memory 108 may comprise other zones comprising instruction codes on the general functioning of the telephone 101, or of the working zones. These zones have not been shown so as not to over-burden the drawing.

In the present example, we have chosen the hashing algorithm MD5 but there are other algorithms such as, for example, the algorithm SHA-1. The particular feature of these algorithms is that, from an original message, they produce a fingerprint which characterizes the original message. The other characteristic of these algorithms is that it is impossible to reconstitute the original message from the digital message resulting from the hashing operation.

For the zone 108c, and in the present example, the algorithm DES has been chosen but there are others such as, for example, the triple DES algorithm which will be used by preference, or again the AES algorithm.

The telephone 101 also has a memory 109 to record an identifier of the user of the telephone 101, for example its MSISDN number, i.e. its telephone number. The telephone 101 also has a memory 110 enabling the recording of a subscriber key, which is actually a signature key proper to the user of the terminal. It is this key that enables the user, for example, to make the message signature. In practice, the memories 109 and 110 can very well be included in a SIM card. The telephone 101 also has a keyboard 111 and a screen 112 by which the user of the telephone 101 can interact with it. The elements 109 to 112 are connected to the bus 106.

These different elements described for the telephone 101 are implemented by the method according to the invention.

FIG. 1 shows a server 113 of an operator of a telecommunications network, for example the operator managing the network 102. The server 113 has interface circuits 114 for connection between the server 113 and the network 102. The circuits 114 are connected to a bus 115. The server 113 has a microprocessor 116 itself also connected to the bus 115. The microprocessor 116 executes instruction codes recorded in a memory 117. The memory 117 has several zones.

A first zone 117A has instruction codes by which the server 113 can act as a gateway for the WAP protocol for example. It is the instruction codes of the zone 117A that enable a user of the terminal 101 to link up to Internet sites through the WAP protocol i.e. link up to sites recorded on a server accessible through the Internet. A zone 117B has instruction codes corresponding to the implementation of the fingerprint computing algorithm.

A zone 117C has instruction codes implementing the DES algorithm. A zone 117D has instruction codes to implement the reception and sending of short messages. A zone 117E has instruction codes to implement PKI technologies. It may be recalled that these technologies comprise especially the implementation of an RSA type asymmetrical enciphering algorithm.

The memory 117 also has a zone 117F comprising instruction codes by which the server 113 can behave like a certification server corresponding to the role of certification authority which, in a preferred embodiment, is incumbent on the operator of the network 102 in the invention. The instruction codes of the zone 117F enable the server 113 to respond to requests coming from providers acting on the Internet, these providers seeking to determine the validity of an X509 certificate.

The server 113 has a memory 118 for the storage of information on the subscribers with the operator to whom the server 113 belongs. The memory 118 is structured as a database. In practice, the memory 118 has been represented as a table comprising as many columns as there are subscribers to the operator's network and as many rows as there are pieces of information to be recorded for each subscriber. FIG. 1 shows some of the rows of the table 118. The table 118 has a row 118A enabling the recording of an identifier of the subscriber, for example his MSISDN number. A row 118B enables the recording of a secret enciphering key (stored in enciphered or unenciphered form) used for the verifications of signatures sent out by the terminal 101. A row 118C enables the recording of a personal code of the terminal 101 enabling, for example, the validation of the procedure of an electronic signature made by the user of the terminal 101. A row 118D enables the recording of the information corresponding to a certificate, for example according to the X509 standard. In this case, the row 118D comprises, for each subscriber holding a certificate, at least the public part of the dual key. The memory 118 is connected to the bus 115.

The server 113 also has an interface 119 for connection with the Internet. The interface 119 is connected to the bus 115.

FIG. 1 shows a set of functions, especially functions relating to the WAP gateway, PKI technology, certification authority and recording of information on subscribers, concentrated on a same server 113. In practice, all these functions can effectively be combined in one and the same server, or they can be distributed on several servers communicating with each other.

The server 113 is therefore connected to the network 120 (the Internet in the present description). Through this network, it can communicate with a server 121 of a provider. A provider is an Internet actor that proposes its services on the Internet, or an actor of another network (a communications means) by which the terminal 101 can receive/send information on a transaction. The transaction may relate to a sales service or to a simple service such as translation for example. In most cases, the server 121 is that of a host, i.e. a person who proposes hosting technologies to providers wishing to act on the Internet. Thus, the server 121 comprises interface circuits 122 providing connection with the Internet 120, a microprocessor 123 capable of executing instruction codes recorded in a memory 124. The memory 124 is divided into several zones, one of these zones 124A comprising instruction codes used to implement algorithms related to the PKI technologies. A zone 124B comprises instruction codes enabling the server 121 to behave like a server known as a WEB server, i.e. these are instruction codes used to implement the HTTP (Hypertext transfer protocol). A zone 124C has instruction codes used to implement the WAP protocol. Thus, a user provided with a terminal such as the telephone 101 can link up to the server 121 which recognizes the WAP protocol. The server 121 also has a memory 125 in which there are recorded different sites, especially that of the provider. The sites are described in the form of files, for example in the WML (Wireless Mark-up Language) format. The elements 122 to 125 are connected via a bus 126.

For the rest of the description, when an action is attributed to an apparatus, whether it is the terminal 101, the server 113 or the server 121, this action is actually performed by the microprocessor of the apparatus controlled by the instruction codes recorded in the program memory of the apparatus. It may also be recalled that a transaction is related to a transaction message, the two terms being used without distinction. The same is the case for signatures and signature messages. Indeed, in practice, a transaction and a signature are represented by a bit sequence, this sequence being then a binary message, i.e. a message formed by bits.

FIG. 2 shows a preliminary step 201 for the display of the transaction. In the step 201, a subscriber to the network 102 uses the terminal 101 to define a transaction. This means that the user of the terminal 101, subscribing to the network 102, uses the keyboard 111 and the screen 112 to set up a connection, for example through the WAP protocol, to a server of a provider. This server then sends information via the server 115 which then behaves like a WAP gateway. The information enables the telephone 101 to display the different services proposed by the provider on the screen 12 of the telephone 101. The user then chooses one of these services, thus obtaining the identifier of this service. Then the user uses the keyboard 111 to validate the transaction. At the time of the validation of the transaction, the user of the telephone 101 (hence the telephone 101) possesses the reference 301 of the article to introduce variability at the level of the computed signature (a serial number managed by the provider, a timestamp, a random value—the list is not exhaustive), the unit price 302 of the article, the quantity 303 of the article that he wishes to acquire, its network identifier 304 on the network 102. This is information on the transaction. Optionally, the user of the terminal 101 also possesses a URL (Universal Resource Locater) 305 by which the recipient of the transaction can obtain data enabling him to verify the validity of the transaction, and especially the validity of the countersignature 310. The totality of the information referred to here above exists in a memory of the telephone 101 in electronic form. This is a file. This file is the set of pieces of information on the nature of a transaction. It is also called a transaction message 306 or transaction T. The invention then passes to a step 202 for making a digest of the transaction T, or producing a fingerprint of the transaction T.

In practice, the transaction message 306 may be displayed in a good many ways. This message may be directly entered by the user on this telephone via the keyboard, obtained via a short message, or any other possibility used to enter/obtain information on the transaction.

In practice, the validation of the transaction is effective only after the user has entered a validation code. This is, for example, a four-figure code whose keying in makes it possible to pass to the following steps. The keying of this code is equivalent to the keying in of the secret code of a visa card when it is used. It ensures the non-repudiation of the payment. Indeed, the person who produced the signature then knew the validation code used to release the steps of production of this signature.

In the step 202 the telephone 101 applies the MD5 algorithm recorded in the zone 108b to the transaction message 306 comprising the information pertaining to the nature of the transaction. Thus, a digital digest of the transaction is obtained. The invention passes to a step 203 of production of the signature.

FIG. 4 too illustrates the step 203. FIG. 4 shows that a signature is produced by using an enciphering algorithm whose inputs are the digital digest of the transaction as well as a secret key of the subscriber. The subscriber's secret key is recorded in the memory 110 of the telephone 101. The result of the signature algorithm is a signature message 307, or a signature 307. The enciphering algorithm used for the production of the signature 307 is, for example, the algorithm of the zone 108c. In general, a signature is applied by applying an enciphering algorithm and a secret key to a fingerprint of the message to be signed.

Once the message 306 and its signature 307 have been obtained, the invention passes to a step 204 for sending this message 306 and its signature 307. They are sent towards the server 113, for example through a short message. However, for the transmission, it is possible to use any transmission protocol, including protocols that provided for en enciphering of the data transmitted. The invention passes to a step 205 for the reception of both the message and its signature by the server 113. The unit formed by the message 306 and its signature 307 is a first message 300 sent by the terminal 101.

In the step 205, the server 113 receives a short message. The header of this short message is used to determine who has sent this message. The server 113 then possesses an identifier of the sender. This is generally the MSISDN number of the sender. Through this identifier, the server 113 is capable of retrieving information on the sender from the table 118. In particular, in the row 118B, it retrieves the secret signature key (enciphered or not enciphered). Through this information, the server 113 is capable of verifying the validity of the signature 307. This verification consists, inter alia, of an inversion of the enciphering that was made on the message summarized by the hashing algorithm at the step 202. This is the signature verification step 206. In the step 206, the deciphering is done with the same key as the one used for the production of the signature because it involves algorithms known as symmetrical algorithms, hence algorithms that work according to the principle of a secret key. In this case, the key is known only to the senders and the receivers.

In the step 206, once the enciphering has been inversed on the signature, the server 113 reproduces the process that had led to obtaining the digest of the transaction, i.e. the server 113 applies the fingerprint computing algorithm (here MD5) to the information on the transaction, hence to the message 306. It then compares the result of the inversion of the enciphering of the signature with its own digest that it has produced. If there is identity, it means that the message has not been altered and that it has been truly transmitted by the person who claims to have sent it. If there is no identity, the transaction goes no further. If there is identity, the invention passes to a step 207 of composing the second message for the provider.

In practice, the operations of verification of a signature are performed by an independent electronic circuit approved by a certifying organization. This approval provides the guarantee that it is impossible to produce an enciphered message (i.e. to generate or regenerate a signature in the present case). Thus, by construction, the independent circuit, also known as a cryptographic board, prohibits the generation or new generation of a signature. This independent circuit inputs the transaction message, the corresponding signature and the secret key of the subscriber who has sent the message and the signature. The independent circuit outputs a message signifying “accurate signature” or “inaccurate signature” as the case may be. This independent circuit is the only one entitled to handle the enciphering algorithms and the associated keys. The independent circuit is incapable of producing a signature. This independent circuit is, for example, a microcircuit connected to the server 113, and communicating with the microprocessor 116. The independent circuit is, for example, inserted into the server 113 in the form of a microcircuit board. The server 113 then has a microcircuit board reader 127 connected to the bus 115. The storage of the user signature keys, enciphered by a key known only to this microcircuit board (or secured enciphering board) ensures that only this microcircuit board is capable of revealing the value of the user key in unenciphered form.

In the step 207, the server 113 produces a digital representation comprising the following information: a reference 301 of the article, a unit price 302, a quantity 303 of articles, the network identity 304 of the user of the terminal 101, a URL 305 for access to the X509 certificate of the user of the terminal 101, a transaction identifier 308 to introduce variability in the computed signature (a serial number managed by the server, a timestamp, a random value: the list is not exhaustive), and the signature 307 as produced by the terminal 101 at the step 203. Let this digital representation be called a message 309. At the step 113, the server 113 then produces a countersignature 310 for the message 309. With the algorithm of the memory 117B (i.e. the algorithm MD5), the server 113 then computes a fingerprint of the unenciphered message 309. The server 113 then makes a search, in the memory 118, for the private key of the X509 circuit corresponding to the operator or to the user of the telephone 101, depending on the variants. The server 113 uses this private key for the enciphering, at the step 209, of the fingerprint of the message 309. Thus, a countersignature 310 is obtained. The server 113 then assembles the message 309 and the countersignature 310 of this message 309. A digital representation/message 311 of the information is obtained in a step 210.

It may be recalled that an X509 certificate comprises the identity of its holder. A link to such a certificate may therefore be considered to be a piece of information on the identity of the user who is the holder of this certificate.

The identifier 308 is, for example, a time index (known as a timestamp in the literature) enabling the transaction to be indexed from this date.

It may be recalled that the enciphering operations, implementing public keys and private keys, are what are called asymmetrical enciphering operations use, for example, the RSA enciphering algorithm.

In practice, the countersignature 310 may be produced by the same independent circuit as the one used for the verification of the signature at the step 206. In this case, said independent circuit is furthermore provided with a private key corresponding to the subscriber or to the operator depending on the variants, and the identifier 308. Thus, for the production of the countersignature, the same guarantee of confidentiality is obtained as for the verification of the signature. It is thus ensured that a countersignature is produced only if a valid signature is received.

The invention passes to the step 210 for sending the message 311 to the provider, i.e. towards communications and processing means of the provider, for example the server 121. Such means are known. This transmission is made, for example, through an e-mail. It is the terminal 101 that gives the server 113 the provider's electronic address. The terminal 101 has obtained this address, for example during a communication with the provider to edit the transaction, or receive a message from the provider. If not, the subscriber must key in an identifier to identify the provider. This identifier then becomes an element of the transaction message 306. In practice, the message 311 can be sent by any protocol whatsoever that is supported by the operator of the network 102 and the provider.

In one variant, an X509 certificate is sent at the same time as the message 311. This averts the need for the recipient of the message 311 to search for said certificate. It may be recalled that an X509 certificate comprises a piece of information used to access a list of repudiated certificates, i.e. an X509 certificate comprises means to verify its validity.

The invention passes to the step 211 for the reception of the message by the provider. In this step, the provider obtains information on a person who wishes to purchase a certain product from him in a certain quantity and at a certain price. Furthermore, the server 121 then possesses an address 305 enabling it to obtain the X509 certificate from the person wishing to make this purchase. This X509 certificate comprises especially the algorithm that was used to produce the signature, as well as the public key of the person wishing to make the transaction. The provider is therefore capable of verifying the validity of the transaction.

There are at least three variants for the operator to countersign the transactions made by its subscribers. A first variant entails the hosting, at the server 113, of all the dual keys and certificates of the subscribers. The invention then implements a secured and non-repudiable transfer of electronic signature (in PKI technology) to a remote terminal. A second variant consists in producing all the dual keys and associated certificates of the subscribers at the level of the operator and hosting them at the server 113 as described in the first variant. A third variant consists in producing a single dual key (at the operator's level) and generating certificates that are different and unique in their contents for each of the subscribers (for example based on their serial numbers) and housing the totality as described for the first and second variants.

In the step 209, the server 121 applies a deciphering to the countersignature 310 produced by the server 113. This deciphering produces a message resulting from a previous hashing performed by the server 113. The knowledge of the hashing algorithm enables the server 121 to recompute this hashing from the message 309, and then compare this result production with the result of the deciphering. If there is identity, it means that the person who has made the transaction is truly the person claiming to have done so. It also means that the contents of the transaction have not been altered during the transmission. The provider can then fulfill his side of the transaction in full confidence.

Thus a transaction is made by the sending of a first message from the user to the operator, this first message comprising the transaction T and its signature, then by the sending of a second message from the operator to the provider, comprising a second transaction and its countersignature. The second transaction then comprises the transaction T, its signature and data added by the operator such as a timestamp.

The invention thus presents many points of interest. Indeed, the production of signatures exchanged between the terminal 101 and the server 113 is done with symmetrical algorithms. These algorithms are highly robust and require little computation power in their implementation. This makes it possible to provide a reliable communications channel between the terminal 101 and the server 113 at low cost. Furthermore, inasmuch as the operator managing the server 113 has numerous means at his disposal to identify his subscribers, i.e. the persons sending messages on the network that he manages, the management of the secret keys is greatly simplified. The operator will always be in a position to know who has sent the message, independently of the value of the secret key used. This thus reduces the number of secret keys to be managed. It also reduces the computation power needed to implement signature production at the terminal 101. This has the effect of shortening the user's waiting time, and also of extending the lifetime of the battery of the terminal 101.

In the invention, it is the operator, managing the server 113, that acts as certification authority, i.e. when a provider receives a transaction, he interrogates the server 113, or another server of the operator to obtain the X509 certificate having performed the transaction, the operator acting as guarantor for his subscribers and the provider countersigning the subscriber/provider transaction with his own dual key. It will be noted however, that the computation power needed for the implementation of the PKI technologies is transferred to the operator's server 113. Such a server is generally more powerful than a terminal 101. This is therefore not inconvenient but rather advantageous. Similarly, such a server is not battery-operated.

The invention furthermore enables the operator to propose additional services, in the context of variants, to his subscribers, for example the management of an X509 certificate. The subscriber no longer has to concern himself with the performance of the steps needed to obtain such certificates since most of the time the operator possesses all the information needed to obtain and produce such a certificate when the subscriber makes a subscription contract with the operator. It can be seen here that the operator truly fulfils all the conditions for acting as recording authority.

The invention can also be implemented if the operator is not a certification authority. In this case, it is enough for the operator to use a certificate which is his to produce the countersignature 310. In this case, it is effectively the operator that acts as guarantor for his subscribers. The operator can do so because he has access to the information given by his subscribers when a subscription is taken out. The operator is therefore capable of refusing transactions according to certain criteria, for example if the amount is too great, or if it is impossible to identify the subscriber (for example in the case of the use of an anonymous prepaid card). The operator therefore has total visibility with respect to the transactions performed on his network. This also constitutes a guarantee for the providers.

The payments corresponding to the transactions may be made by the operator who can then pass them on to the subscriber's invoice.

In one variant of the invention, there is provision for an enciphering of messages exchanged between the terminal and servers. This enciphering is either intrinsic to the protocols used, or implemented by the terminal and the servers. This enciphering provides an additional assurance of confidentiality.

In one variant, the items of information registered in the table 118 are enciphered, especially the row 118B. In this case the deciphering key, or storage key, is known only to the elements of the server 113 that have used these items of information, for example the independent circuit.

In one variant of the invention, the transaction T is transmitted to the user by the provider in the form of a proposal. This proposal is then signed by the provider. This proposal goes through the operator. The operator is then in charge of verifying the validity of the signature of the proposal. If this signature is valid, then the operator forwards the proposal to the user. The reception and the consultation of this proposal then correspond to the step 201. The user receiving such a proposal is then assured of its validity because this validity is guaranteed by the operator.

1. electronic signature method, characterized by the fact that it comprises the following steps:
information is edited (201) on a terminal of the user, this information pertaining to the nature of a transaction T between the user and a provider,
a signature of the transaction T is produced (203) at the terminal to authenticate the transaction T and the author of the transaction T,
on the terminal, there is produced a first message comprising the information relative to the nature of the transaction T and its signature, said signature being produced by the implementation of a symmetrical algorithm,
the first message is sent (204), from the terminal to the server of a telecommunications operator,
the first message is received (205) on the server of the telecommunications operator,
the user of the terminal is identified on the server,
the validity of the signature is verified (206), on the server,
a second transaction, comprising the transaction T, the signature of the user of the terminal and information on the identity of the user of the terminal, is produced (207) on the server,
a signature corresponding to the second transaction is produced (209), this signature being called the operator's countersignature, said countersignature being produced by the implementation of an algorithm called an asymmetrical algorithm,
a second message, comprising the second transaction and its countersignature by the operator, is sent (210) from the server to the provider who is party to the transaction T.

2. Method according to claim 1, characterized by the fact that a dual key used (209) for the computation of the countersignature is the one attached to the operator.

3. Method according to claim 1, characterized by the fact that the signature of the transaction T is produced by using an enciphering algorithm initialized by a signature key proper to the user of the terminal.

4. Method according to claim 1, characterized by the fact that the second message and the countersignature are sent via a short message.

5. Method according to claim 1, characterized by the fact that the pieces of information on the user's identity are a link to a certificate, preferably according to the X509 standard, delivered by a certification authority.

6. Method according to claim 1, characterized by the fact that the second message furthermore comprises a transaction identifier.

7. Method according to claim 1, characterized by the fact that the countersignature is made by the use of the dual key and the X509 certificate of the subscriber who is a party to the transaction T, hosted by the operator.

8. Method according to claim 1, characterized by the fact that the countersignature is made by use of a particular dual key, hosted by the operator, and for which several X509 subscriber certificates have been generated, these certificates being all unique in their serial number.

9. Method according to claim 1, characterized by the fact that the operator analyzes the signature of the transaction signed by the provider and sent by the provider before it is sent to the subscriber, this verification enabling the subscriber to guarantee the validity of the transaction before signature.
